(19) United States
(12) Patent Application Publication
(10) Pub. No.: US 2023/0367113 A1
(43) Pub. Date: Nov. 16, 2023

(54) DRIVE ELEMENT AND LIGHT DEFLECTION ELEMENT

(71) Applicant: Panasonic Intellectual Property Management Co., Ltd., Osaka (JP)

(72) Inventors: Kensuke MIHARA, Osaka (JP); Ryouichi TAKAYAMA, Osaka (JP)

(21) Appl. No.: 18/226,629

(22) Filed: Jul. 26, 2023

Related U.S. Application Data
(63) Continuation of application No. PCT/JP2021/043298, filed on Nov. 25, 2021.

(30) Foreign Application Priority Data
Jan. 26, 2021 (JP) 2021-010357

(51) Int. Cl. G02B 26/10; G02B 26/08

(52) U.S. Cl. CPC G02B 26/10; G02B 26/0858

(57) ABSTRACT

A drive element includes: a movable part; a drive part configured to rotate the movable part about a rotation axis; and a connection part connecting the drive part to a fixing part. The movable part, the drive part, and the fixing part are aligned along the rotation axis. The connection part is connected to the fixing part via at least one pair of joint surfaces that are not orthogonal to the rotation axis and that are symmetrical with respect to the rotation axis.

### CROSS REFERENCE TO RELATED APPLICATION

This application is a continuation of International Application No. PCT/JP2021/043298 filed on Nov. 25, 2021, entitled “DRIVE ELEMENT AND LIGHT DEFLECTION ELEMENT”, which claims priority under 35 U.S.C. Section 119 of Japanese Patent Application No. 2021-010357 filed on Jan. 26, 2021, entitled “DRIVE ELEMENT AND LIGHT DEFLECTION ELEMENT”. The disclosures of the above applications are incorporated herein by reference.

### BACKGROUND OF THE INVENTION

### Field of the Invention

The present invention relates to a drive element that rotates a movable part about a rotation axis, and a light deflection element using the drive element.

### Description of Related Art

In recent years, by using micro electro mechanical system (MEMS) technology, drive elements that rotate a movable part have been developed. In this type of drive element, a reflection surface is located on the movable part, thereby allowing scanning to be performed at a predetermined deflection angle with light incident on the reflection surface. This type of drive element is installed in image display devices such as head-up displays and head-mounted displays. In addition, this type of drive element can also be used in laser radars that use laser beams to detect objects, etc.

Japanese Patent No. 5045470 describes a drive element of a type that rotates a movable part by a so-called tuning fork-type vibrator. In this drive element, piezoelectric drivers are respectively disposed on a pair of arm parts extending along a rotation axis. When AC voltages having phases different from each other by 180° (opposite phases) are applied to these piezoelectric drivers, respectively, the pair of arm parts expand and contract in directions opposite to each other. As a result, the movable part rotates about the rotation axis, and a reflection surface located on the movable part rotates accordingly. The tuning fork-type vibrator is connected to an outer frame via a connection part extending along the rotation axis. The outer frame forms a fixing part for fixing the drive element to an installation surface.

In the case where the drive element configured as described above is used, for example, in a laser scanning-type image display device, the movable part on which the reflection surface is located is required to be driven at a high frequency and a high deflection angle. In this case, in the configuration of Japanese Patent No. 5045470, high stress may be applied to the connection part for connecting the tuning fork-type vibrator to the outer frame, and the connection part may be broken by this stress.

### SUMMARY OF THE INVENTION

A first aspect of the present invention is directed to a drive element. The drive element according to this aspect includes: a movable part; a drive part configured to rotate the movable part about a rotation axis; and a connection part connecting the drive part to a fixing part. The movable part, the drive part, and the fixing part are aligned along the rotation axis. The connection part is connected to the fixing part via at least one pair of joint surfaces. The pair of joint surfaces are not orthogonal to the rotation axis and are symmetrical with respect to the rotation axis.

In the drive element according to this aspect, since the at least one pair of joint surfaces which are symmetrical to the rotation axis are not perpendicular to the rotation axis, as compared to the case where a joint surface is perpendicular to the rotation axis, stress generated on each joint surface during rotation of the movable part is likely to be spread and dispersed over the joint surface, so that localization of high stress on a part of the joint surface is alleviated. Therefore, even when the movable part is driven at a high frequency and a high deflection angle, occurrence of breaking of the connection part due to the stress generated during the drive can be suppressed.

A second aspect of the present invention is directed to a light deflection element. The light deflection element according to this aspect includes the drive element according to the first aspect and a reflection surface located on the movable part.

Since the light deflection element according to this aspect includes the drive element according to the first aspect, even when the movable part is driven at a high frequency and a high deflection angle, occurrence of breaking of the connection part due to the stress generated during the drive can be suppressed. Therefore, deflection of and scanning with light can be performed at a high frequency and a high deflection angle by the reflection surface.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1 is a perspective view showing a configuration of a drive element according to Embodiment 1;

FIG. 2 is a plan view showing the configuration of the drive element according to Embodiment 1;

FIG. 3 is a perspective view showing a configuration of a drive element according to a comparative example;

FIG. 4 is a plan view showing the configuration of the drive element according to the comparative example;

FIG. 5A is a plan view showing locations where high stress is localized on a joint surface according to the comparative example;

FIG. 5B is a diagram showing a simulation result of examining a stress distribution state on the joint surface according to the comparative example.

FIG. 6A is a plan view showing ranges where stress is increased on joint surfaces according to Embodiment 1;

FIG. 6B is a diagram showing a simulation result of examining stress distribution states on the joint surfaces according to Embodiment 1;

FIG. 7A is a plan view schematically showing a stress propagation state according to the comparative example;

FIG. 7B is a plan view schematically showing a stress propagation state according to Embodiment 1;

FIG. 8 is a perspective view showing a configuration of a drive element according to Embodiment 2;

FIG. 9 is a plan view showing the configuration of the drive element according to Embodiment 2;

FIG. 10A is a plan view showing ranges where stress is increased on joint surfaces according to Embodiment 2;

FIG. 10B is a diagram showing a simulation result of examining stress distribution states on the joint surfaces according to Embodiment 2;

FIG. 11A is a diagram illustrating dispersion of stress according to Embodiment 2;

FIG. 11B is a diagram illustrating dispersion of stress according to Embodiment 1;

FIG. 12A, FIG. 12B, and FIG. 12C are each a plan view schematically showing a joining mode between a connection part and a fixing part according to a modification; and

FIG. 13A, FIG. 13B, and FIG. 13C are each a plan view schematically showing a joining mode between a connection part and a fixing part according to a modification.

It should be noted that the drawings are solely for description and do not limit the scope of the present invention by any degree.

### DETAILED DESCRIPTION

Hereinafter, embodiments of the present invention will be described with reference to the drawings.

In each of the following embodiments, a reflection surface is located on a movable part of a drive element, whereby a light deflection element is configured. For convenience, in each drawing, X, Y, and Z axes that are orthogonal to each other are additionally shown. The Y-axis direction is a direction parallel to a rotation axis of a drive element, and the Z-axis direction is a direction perpendicular to the reflection surface located on the movable part.

### Embodiment 1

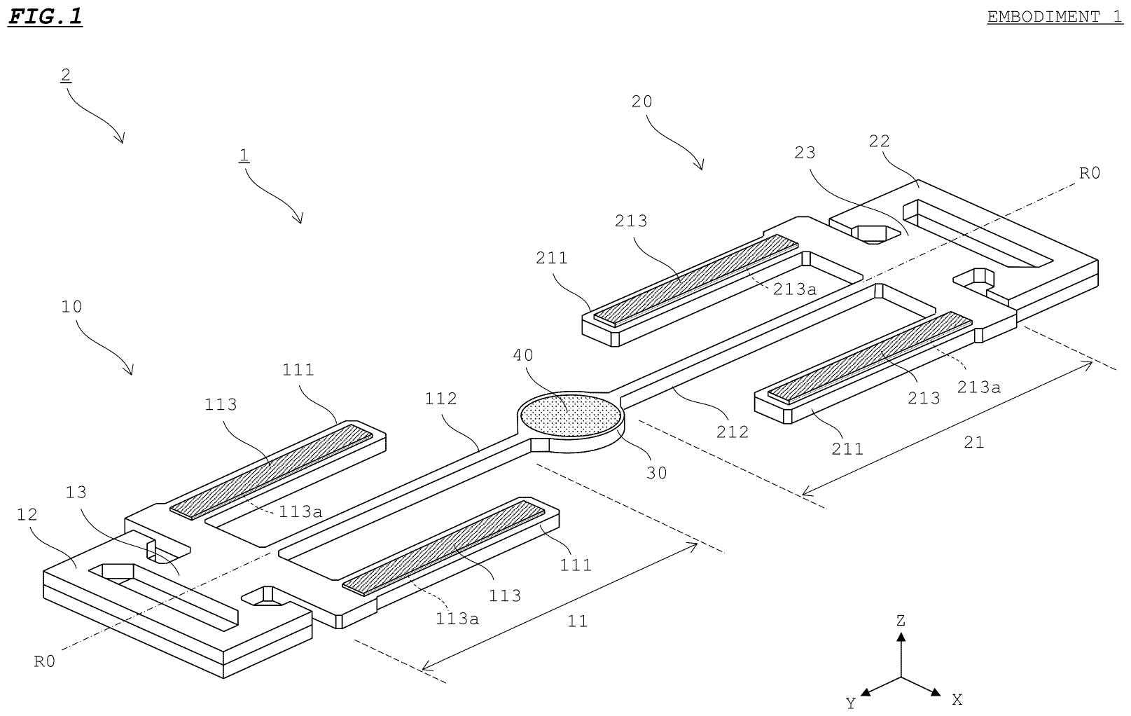

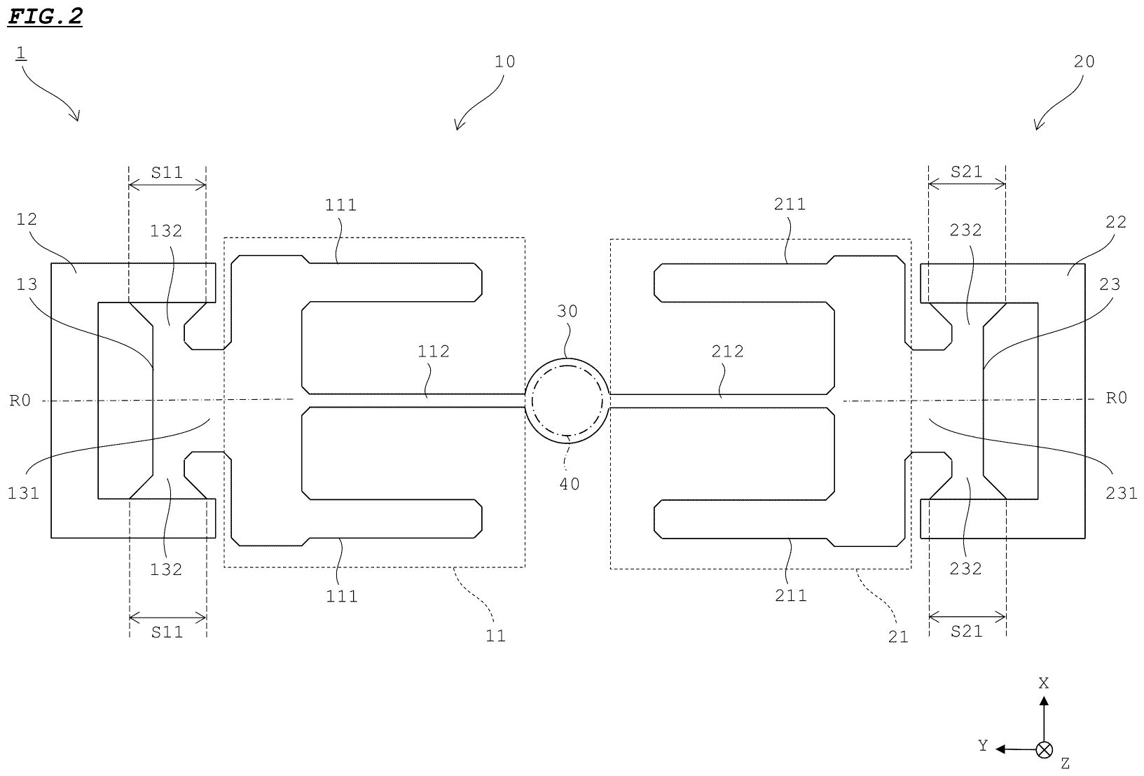

FIG. 1 is a perspective view showing a configuration of a drive element 1, and FIG. 2 is a plan view showing the configuration of the drive element 1. FIG. 2 shows a plan view of the drive element 1 as viewed from a lower surface side (Z-axis negative side).

As shown in FIG. 1 and FIG. 2, the drive element 1 includes a first drive unit 10, a second drive unit 20, and a movable part 30. In addition, a reflection surface 40 is located on the upper surface of the movable part 30, whereby a light deflection element 2 is configured. The drive element 1 has a symmetrical shape in the X-axis direction and the Y-axis direction in a plan view.

The first drive unit 10 and the second drive unit 20 rotate the movable part 30 about a rotation axis R0 in response to drive signals supplied thereto from drive circuits which are not shown. The reflection surface 40 reflects light incident thereon from above the movable part 30, in a direction corresponding to a deflection angle of the movable part 30. Accordingly, as the movable part 30 rotates, the light (e.g., laser beam) incident on the reflection surface 40 is deflected and scanning is performed with this light. The movable part 30 and the reflection surface 40 may be formed of the same member.

The first drive unit 10 includes a drive part 11, a fixing part 12, and a connection part 13. The movable part 30, the drive part 11, and the fixing part 12 are aligned along the rotation axis R0. The connection part 13 is connected to the fixing part 12 via a pair of joint surfaces S11. The joint surfaces S11 are parallel to the rotation axis R0 and are located so as to be symmetrical in the X-axis direction with respect to the rotation axis R0.

The connection part 13 includes a support portion 131 extending along the rotation axis R0 from the drive part 11, and leg portions 132 connected to the outer side of the support portion 131. The fixing part 12 is formed in a C-shape surrounding the leg portions 132 in a plan view. The leg portions 132 are joined to the inner surface of the fixing part 12 to form the joint surfaces S11.

The second drive unit 20 includes a drive part 21, a fixing part 22, and a connection part 23. The movable part 30, the drive part 21, and the fixing part 22 are aligned along the rotation axis R0. The connection part 23 is connected to the fixing part 22 via a pair of joint surfaces S21. The joint surfaces S21 are parallel to the rotation axis R0 and are located so as to be symmetrical in the X-axis direction with respect to the rotation axis R0.

The connection part 23 includes a support portion 231 extending along the rotation axis R0 from the drive part 21, and leg portions 232 connected to the outer side of the support portion 231. The fixing part 22 is formed in an inverted C-shape surrounding the leg portions 232 in a plan view. The leg portions 232 are joined to the inner surface of the fixing part 22 to form the joint surfaces S21.

The first drive unit 10 and the second drive unit 20 are placed in orientations opposite to each other with the movable part 30 located therebetween. The drive part 11 of the first drive unit 10 and the drive part 21 of the second drive unit 20 are connected to the movable part 30.

The drive part 11 is a tuning fork-type vibrator. The drive part 11 includes a pair of arm portions 111 extending in an L-shape from the rotation axis R0, a torsion portion 112 extending in a straight manner along the rotation axis R0, and piezoelectric drivers 113 formed on the upper surfaces of the pair of arm portions 111, respectively. An end portion on the Y-axis negative side of the torsion portion 112 is connected to the movable part 30. The piezoelectric drivers 113 are formed on the upper surfaces of straight portions, of the arm portions 111, extending in the Y-axis direction.

The drive part 21 is a tuning fork-type vibrator. The drive part 21 includes a pair of arm portions 211 extending in an L-shape from the rotation axis R0, a torsion portion 212 extending in a straight manner along the rotation axis R0, and piezoelectric drivers 213 formed on the upper surfaces of the pair of arm portions 211, respectively. An end portion on the Y-axis positive side of the torsion portion 212 is connected to the movable part 30. The piezoelectric drivers 213 are formed on the upper surfaces of straight portions, of the arm portions 211, extending in the Y-axis direction.

The piezoelectric drivers 113 and 213 each have a lamination structure in which electrode layers are placed on the upper and lower sides of a piezoelectric thin film 113a or 213a having a predetermined thickness, respectively. The piezoelectric thin films 113a and 213a are made of, for example, a piezoelectric material having a high piezoelectric constant, such as lead zirconate titanate (PZT). The electrode layers are made of a material having low electrical resistance and high heat resistance, such as platinum (Pt). The piezoelectric drivers 113 and 213 are each placed on the upper surface of the arm portion 111 or 211 by forming the lamination structure, which includes the piezoelectric thin film 113a or 213a and the electrode layers on the upper and lower sides thereof, on the upper surface of the arm portion 111 or 211 by a sputtering method or the like.

A substrate of the drive element 1 has the same contour as the drive element 1 in a plan view, and has a constant thickness. The reflection surface 40 and the piezoelectric drivers 113 and 213 are placed in corresponding regions of the upper surface of the substrate. The thicknesses of the fixing parts 12 and 22 are increased by further stacking a predetermined material on the lower surfaces of portions, of the substrate, corresponding to the fixing parts 12 and 22. The material stacked on the fixing parts 12 and 22 may be a material different from that of the substrate, or may be the same material as the substrate.

The substrate is, for example, integrally formed from silicon or the like. However, the material forming the substrate is not limited to silicon, and may be another material. The material forming the substrate is preferably a material having high mechanical strength and Young's modulus, such as metal, crystal, glass, and resin. As such a material, in addition to silicon, titanium, stainless steel, Elinvar, a brass alloy, etc., can be used. The same applies to the material stacked on the substrate at each of the fixing parts 12 and 22.

The inventors examined stress generated on the joint surfaces S11 when the movable part 30 was rotated about the rotation axis R0 in the above configuration, in comparison with a configuration of a conventional comparative example.

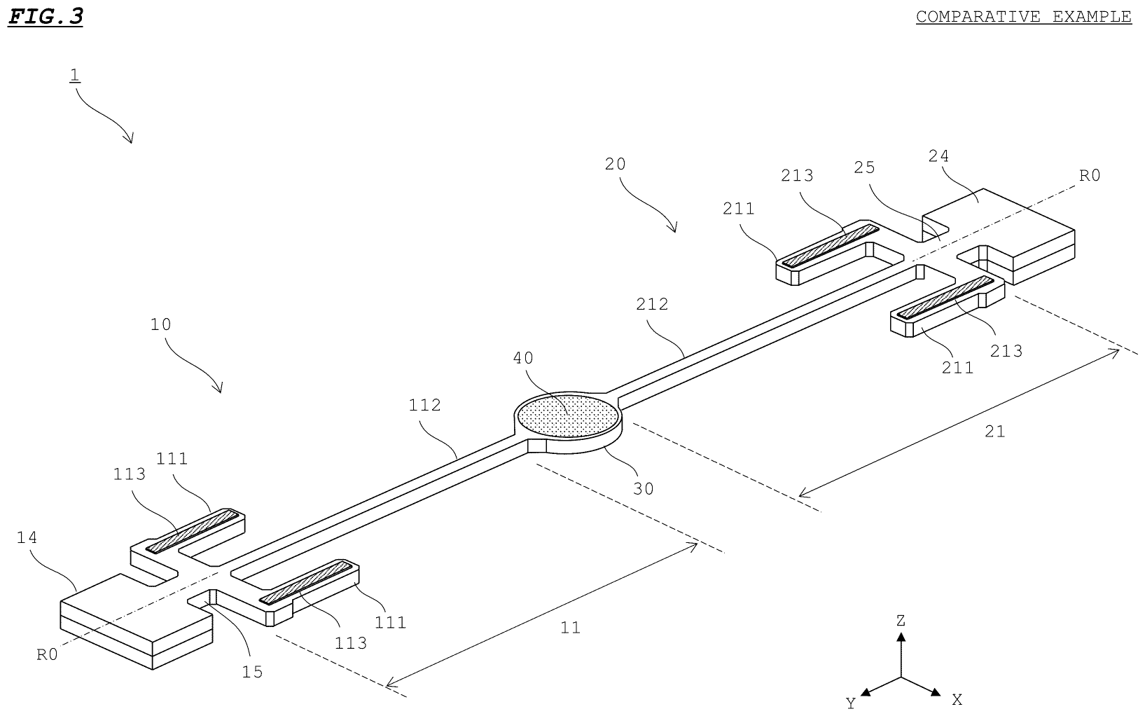

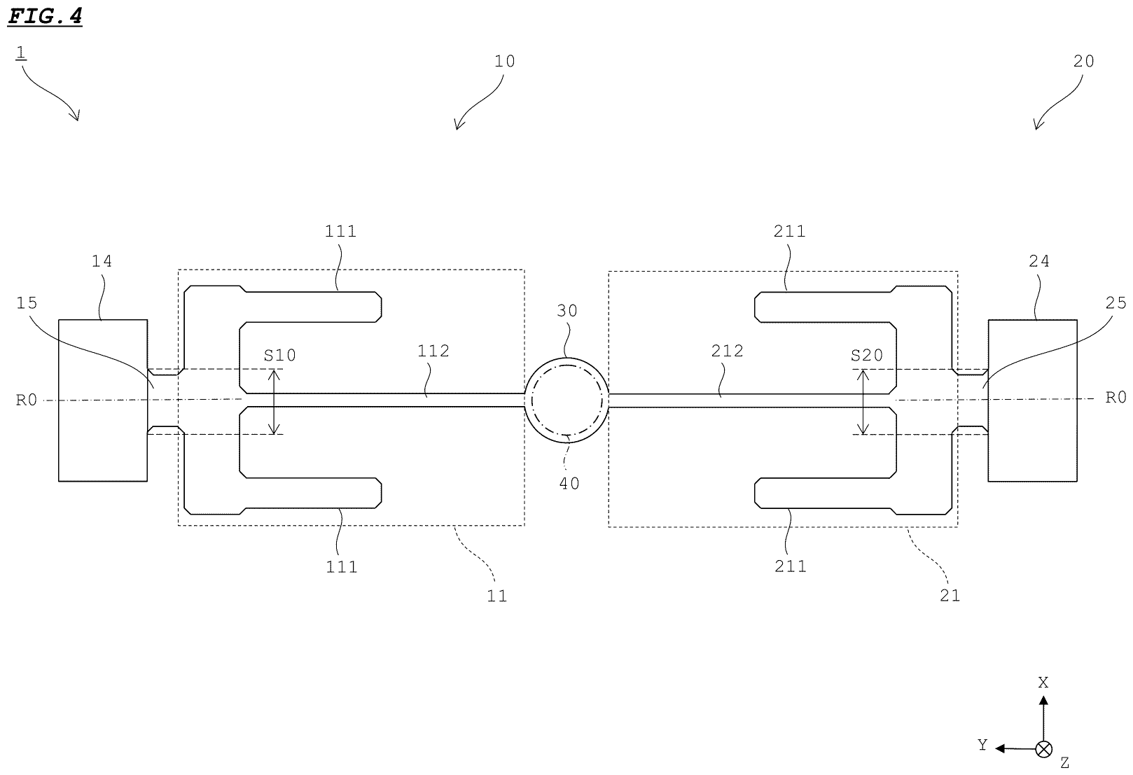

FIG. 3 is a perspective view showing a configuration of a drive element 1 according to the comparative example, and FIG. 4 is a plan view showing the configuration of the drive element 1 according to the comparative example.

The drive element 1 of the comparative example is different from the drive element 1 of Embodiment 1 in configurations of fixing parts 14 and 24 and connection parts 15 and 25. The connection parts 15 and 25 have configurations in which the leg portions 132 and 232 are omitted from the configurations of the connection parts 13 and 23 of Embodiment 1 and only the support portions 131 and 231 are left. In addition, the fixing parts 14 and 24 each have a rectangular shape in a plan view. In the comparative example, joint surfaces S10 and S20 between the fixing parts 14 and 24 and the connection parts 15 and 25 are perpendicular to the rotation axis R0. The other configuration in the drive element 1 of the comparative example is the same as in Embodiment 1.

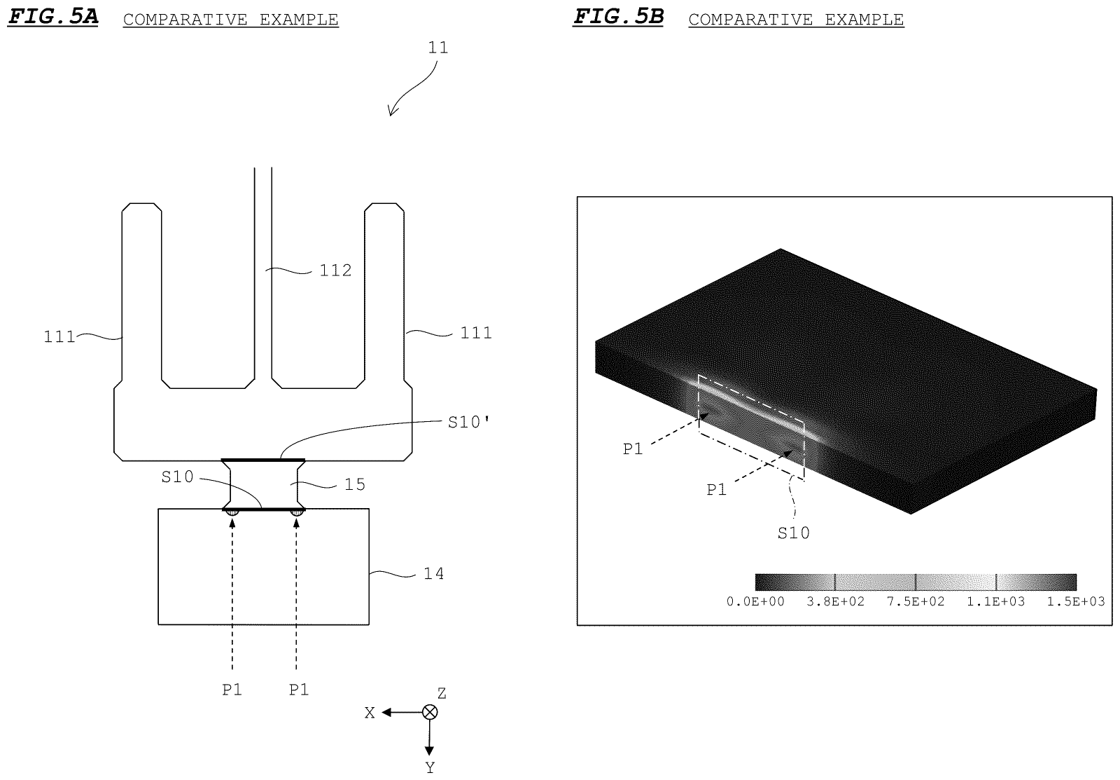

FIG. 5A is a plan view showing locations where high stress is localized on the joint surface S10 according to the comparative example. FIG. 5B is a diagram showing a simulation result of examining a stress distribution state on the joint surface S10 according to the comparative example. For convenience, in FIG. 5B, a simulation result with a minimum value in blue and a maximum value in red is shown in grayscale.

FIG. 5B shows a stress distribution when the movable part 30 was rotated at a maximum deflection angle. FIG. 5A and FIG. 5B show the stress distribution on the joint surface S10 of the first drive unit 10 in the configuration of the comparative example, but a stress distribution on the joint surface S20 of the second drive unit 20 in the configuration of the comparative example is also the same as in FIG. 5A and FIG. 5B.

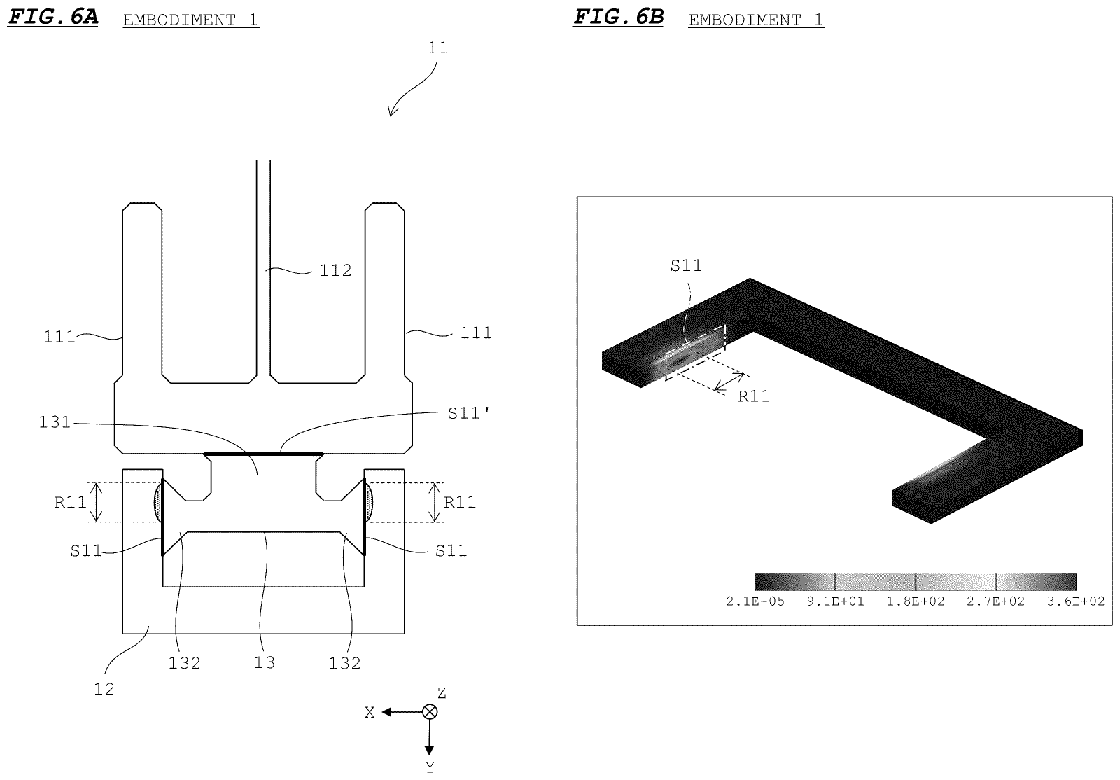

FIG. 6A is a plan view showing ranges where stress is increased on the joint surfaces S11 according to Embodiment 1. FIG. 6B is a diagram showing a simulation result of examining stress distribution states on the joint surfaces S11 according to Embodiment 1. For convenience, in FIG. 6B, a simulation result with a minimum value in blue and a maximum value in red is shown in grayscale.

As in the comparative example, FIG. 6B shows a stress distribution when the movable part 30 was rotated at a maximum deflection angle. FIG. 6A and FIG. 6B show the stress distributions on the joint surfaces S11 of the first drive unit 10 in the configuration of Embodiment 1, but stress distributions on the joint surfaces S21 of the second drive unit 20 in the configuration of Embodiment 1 are the same as in FIG. 6A and FIG. 6B.

In the above simulations, the maximum deflection angle of the movable part 30 was set to the same angle in the comparative example and Embodiment 1. As shown in FIG. 5A and FIG. 5B, in the comparative example, high stress was concentrated at positions P1 near both ends of the joint surface S10. On the other hand, in Embodiment 1, as shown in FIG. 6A and FIG. 6B, stress was dispersed to ranges R11 on the joint surfaces S11, and the magnitude of the stress was also significantly reduced as compared to the comparative example.

Furthermore, the inventors examined a maximum stress value when the size relationship between a joint surface S11′ on the arm portion 111 side and the joint surfaces S11 on the fixing part 12 side of the connection part 13 shown in FIG. 6A was changed, in comparison with the case of the configuration of the comparative example. In the comparative example shown in FIG. 5A, the widths in the X-axis direction of a joint surface S10′ on the arm portion 111 side and the joint surface S10 on the fixing part 14 side of the connection part 15 are equal to each other.

In the examination, the widths in the X-axis direction of the joint surface S10′ of the comparative example and the joint surface S11′ of Embodiment 1 were both set to 1.1 mm. In this state, the width in the Y-axis direction of each joint surface S11 of Embodiment 1 was set to 0.5 mm and 0.6 mm, and maximum stress values generated on the joint surfaces S11 were obtained by simulation. That is, a change of the maximum stress values generated on the joint surfaces S11 when the total area of the two joint surfaces S11 was smaller than that of the joint surface S11′ (when the width of each joint surface S11 was 0.5 mm) and when the total area of the two joint surfaces S11 was larger than that of the joint surface S11′ (when the width of each joint surface S11 was 0.6 mm) was obtained by simulation. In the comparative example, since the widths in the X-axis direction of the joint surfaces S10 and S10′ were equal to each other as described above, the areas of the joint surfaces S10 and S10′ were equal to each other. In addition, in the examination, the distance between the joint surface S10′ and the joint surface S10 in the comparative example and the distance between the joint surface S11′ and each joint surface S11 in Embodiment 1 were set to be the same.

The stress generated on the joint surfaces S10 and S11 under the above conditions was obtained by simulation. As a result, in the comparative example, as in FIG. 5B, stress was localized at the positions P1 at both ends of the joint surface S10, and the maximum stress value generated at these positions P1 was 1804 MPa. On the other hand, in Embodiment 1, as in FIG. 6B, stress was dispersed to the ranges R11 on the two joint surfaces S11, and the maximum stress value generated in these ranges R11 was 1562 MPa and 945 MPa when the width in the Y-axis direction of each joint surface S11 was 0.5 mm and 0.6 mm, respectively.

As described above, in this examination, it is confirmed that even when the total area of the two joint surfaces S11 was slightly smaller than the area of the joint surface S11′ (when the width of each joint surface S11 was 0.5 mm), the maximum stress value generated on the joint surfaces S11 was lower than the maximum stress value generated on the joint surface S10 of the comparative example. In addition, it is confirmed that when the total area of the two joint surfaces S11 was larger than the area of the joint surface S11′ (when the width of each joint surface S11 was 0.6 mm), the maximum stress value generated on the joint surfaces S11 was significantly lower than that of the comparative example.

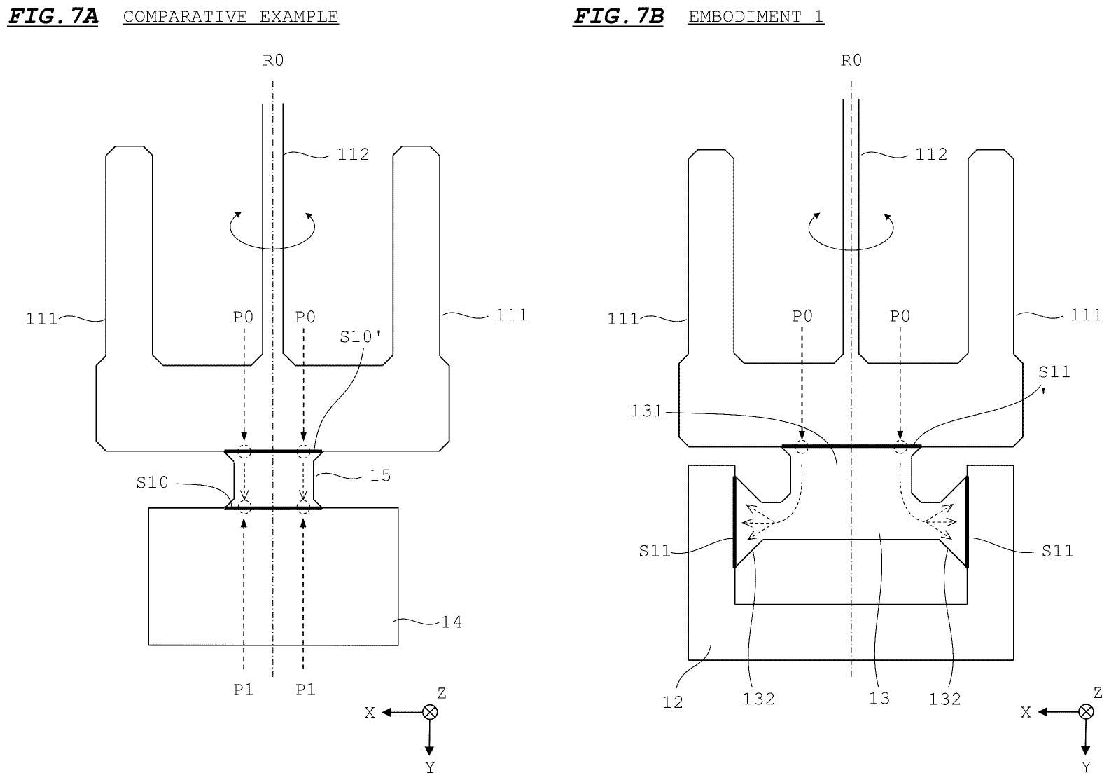

FIG. 7A is a plan view schematically showing a stress propagation state according to the comparative example, and FIG. 7B is a plan view schematically showing a stress propagation state according to Embodiment 1.

As shown in FIG. 7A, in the comparative example, stress is concentrated at positions P0 at both ends in the X-axis direction of the joint surface S10′ due to rotation of the arm portions 111. In the comparative example, since the joint surface S10 is perpendicular to the rotation axis R0, the stress localized at the positions P0 on the joint surface S10′ is reflected to the positions P1 at both ends in the X-axis direction of the joint surface S10. Therefore, as in the above examination result, high stress is localized at the positions P1 at both ends of the joint surface S10.

On the other hand, in Embodiment 1, since the pair of joint surfaces S11 are located so as to be symmetrical with respect to the rotation axis R0 and are parallel to the rotation axis R0, stress localized at positions P0 on the joint surface S11′ is dispersed to the two joint surfaces S11 as shown in FIG. 7B. Therefore, as in the above examination result, the stress generated on each of the two joint surfaces S11 is alleviated, and the maximum stress value is reduced. Therefore, in the configuration of Embodiment 1, when the movable part 30 is driven at a high frequency and a high deflection angle, occurrence of damage to each joint surface S11 due to the stress generated during the drive can be suppressed as compared to the configuration of the comparative example.

### Effects of Embodiment 1

According to Embodiment 1, the following effects can be achieved.

Since the pair of joint surfaces S11 which are symmetrical with respect to the rotation axis R0 are not perpendicular to the rotation axis R0 as shown in FIG. 2, as compared to the case where the joint surface S10 is perpendicular to the rotation axis R0 as in the comparative example shown in FIG. 4, the stress generated on each joint surface S11 during rotation of the movable part 30 is likely to be spread and dispersed over the joint surface S11, so that localization of high stress on a part of the joint surface S11 is alleviated. Therefore, even when the movable part 30 is driven at a high frequency and a high deflection angle, occurrence of breaking of the connection part 13 due to the stress generated during the drive can be suppressed, and deflection of and scanning with light can be performed at a high frequency and a high deflection angle by the reflection surface 40.

As shown in FIG. 2, the connection part 13 includes the support portion 131 extending along the rotation axis R0 from the drive part 11, and the total area of the joint surfaces S11 is larger than a cross-sectional area, perpendicular to the rotation axis R0, of the support portion 131. Accordingly, as shown in the above simulation result, the maximum stress generated on each joint surface S11 can be significantly reduced. Therefore, even when the movable part 30 is driven at a high frequency and a high deflection angle, occurrence of breaking of the connection part 13 due to the stress generated during the drive can be more effectively suppressed.

In the configuration of FIG. 2, the connection part 13 is connected to the drive part 11 via the support portion 131 which has a constant width along the X-axis and which extends along the rotation axis R0, but the connection part 13 may not necessarily have the support portion 131 having this shape. For example, as for the shape of the support portion 131 in a plan view, the width in the X-axis direction may gradually decrease in the Y-axis positive direction, or the support portion 131 may be narrowed in the X-axis direction such that the width thereof is the minimum at a middle position in the Y-axis direction of the support portion 131. In such a case, by setting the total area of the joint surfaces S11 to be larger than the minimum cross-sectional area, perpendicular to the rotation axis R0, of the support portion 131, the stress generated on each joint surface S11 can be effectively reduced.

As shown in FIG. 2, in Embodiment 1, the pair of joint surfaces S11 are parallel to the rotation axis R0. Accordingly, as shown in the above simulation result, the maximum stress generated on each joint surface S11 can be properly reduced.

As shown in FIG. 1 and FIG. 2, the first drive unit 10, which includes the drive part 11, the connection part 13, and the fixing part 12, and the second drive unit 20, which includes the drive part 21, the connection part 23, and the fixing part 22, are placed in orientations opposite to each other with the movable part 30 located therebetween, and the drive parts 11 and 21 of the respective drive units are connected to the movable part 30. By supporting and driving the movable part 30 by the respective drive units as described above, the movable part 30 can be stably driven with a larger torque.

As shown in FIG. 1, the drive parts 11 and 21 are tuning fork-type vibrators, and have the piezoelectric thin films 113a and 213a as drive sources. Accordingly, the movable part 30 can be smoothly and repeatedly rotated about the rotation axis R0.

### Embodiment 2

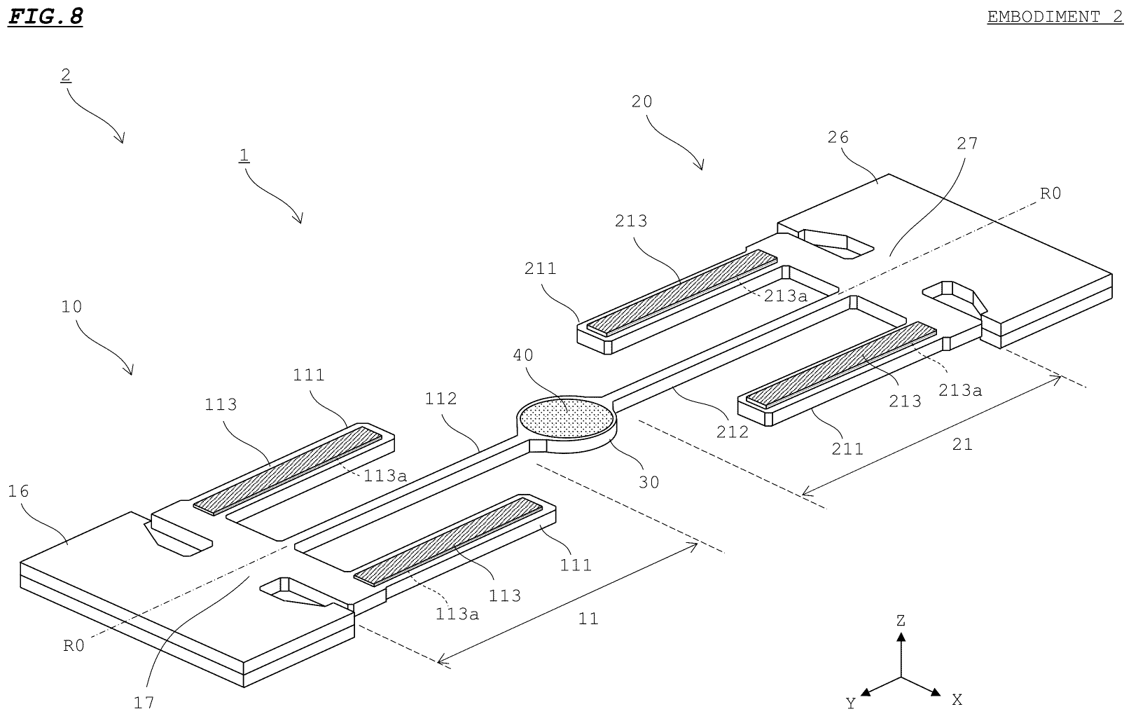

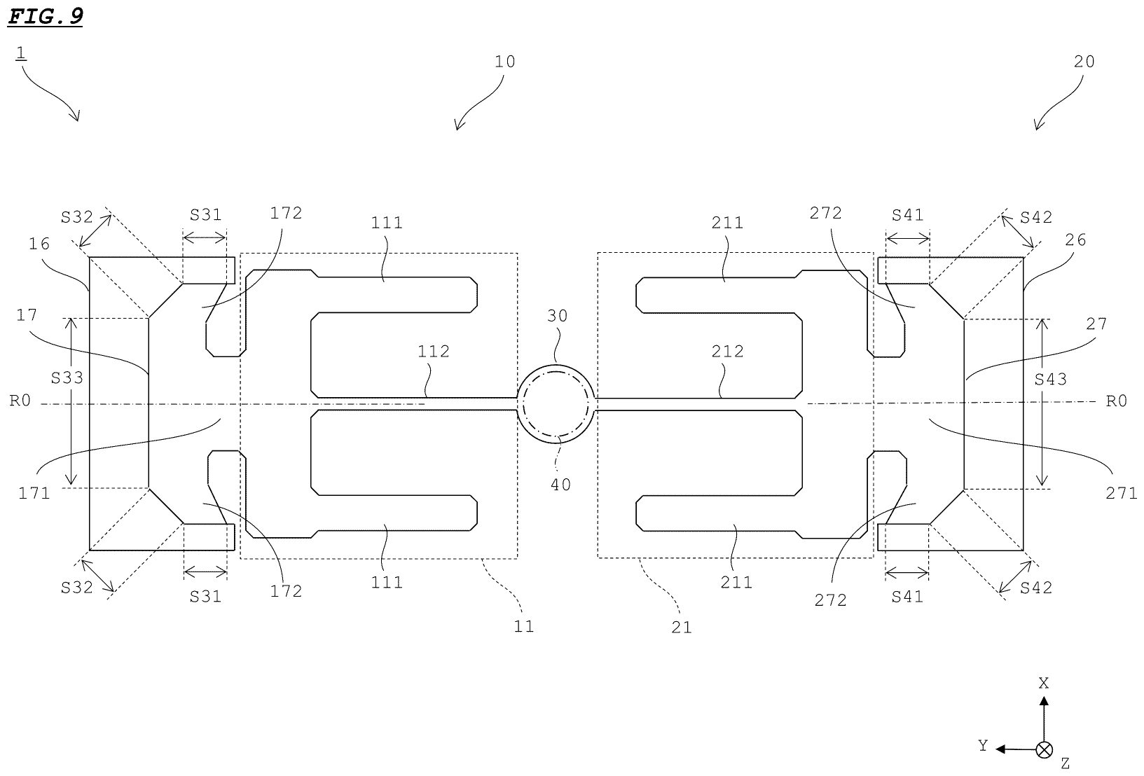

FIG. 8 is a perspective view showing a configuration of a drive element 1 according to Embodiment 2, and FIG. 9 is a plan view showing the configuration of the drive element 1 according to Embodiment 2. FIG. 9 shows a plan view of the drive element 1 as viewed from a lower surface side (Z-axis negative side).

Embodiment 2 is different from Embodiment 1 in configurations of fixing parts 16 and 26 and connection parts 17 and 27. The other configuration in Embodiment 2 is the same as in Embodiment 1. In Embodiment 2 as well, the drive element 1 has a symmetrical shape in the X-axis direction and the Y-axis direction in a plan view.

As shown in FIG. 9, the connection part 17 includes a support portion 171 extending in a straight manner along the rotation axis R0 from the pair of arm portions 111, and leg portions 172 connected to the outer side of the support portion 171. The fixing part 16 is formed in a C-shape surrounding the leg portions 172 in a plan view. The connection part 17 is joined to the fixing part 16 via a pair of joint surfaces S31 and a pair of joint surfaces S32 which are symmetrical with respect to the rotation axis R0 in a plan view and a joint surface S33 which is perpendicular to the rotation axis R0. The pair of joint surfaces S31 are parallel to the rotation axis R0, and the pair of joint surfaces S32 are inclined at an acute angle relative to the rotation axis R0.

Similarly, the connection part 27 includes a support portion 271 extending in a straight manner along the rotation axis R0 from the pair of arm portions 211, and leg portions 272 connected to the outer side of the support portion 271. The fixing part 26 is formed in an inverted C-shape surrounding the leg portions 272 in a plan view. The connection part 27 is joined to the fixing part 26 via a pair of joint surfaces S41 and a pair of joint surfaces S42 which are symmetrical with respect to the rotation axis R0 in a plan view and a joint surface S43 which is perpendicular to the rotation axis R0. The pair of joint surfaces S41 are parallel to the rotation axis R0, and the pair of joint surfaces S42 are inclined at an acute angle relative to the rotation axis R0.

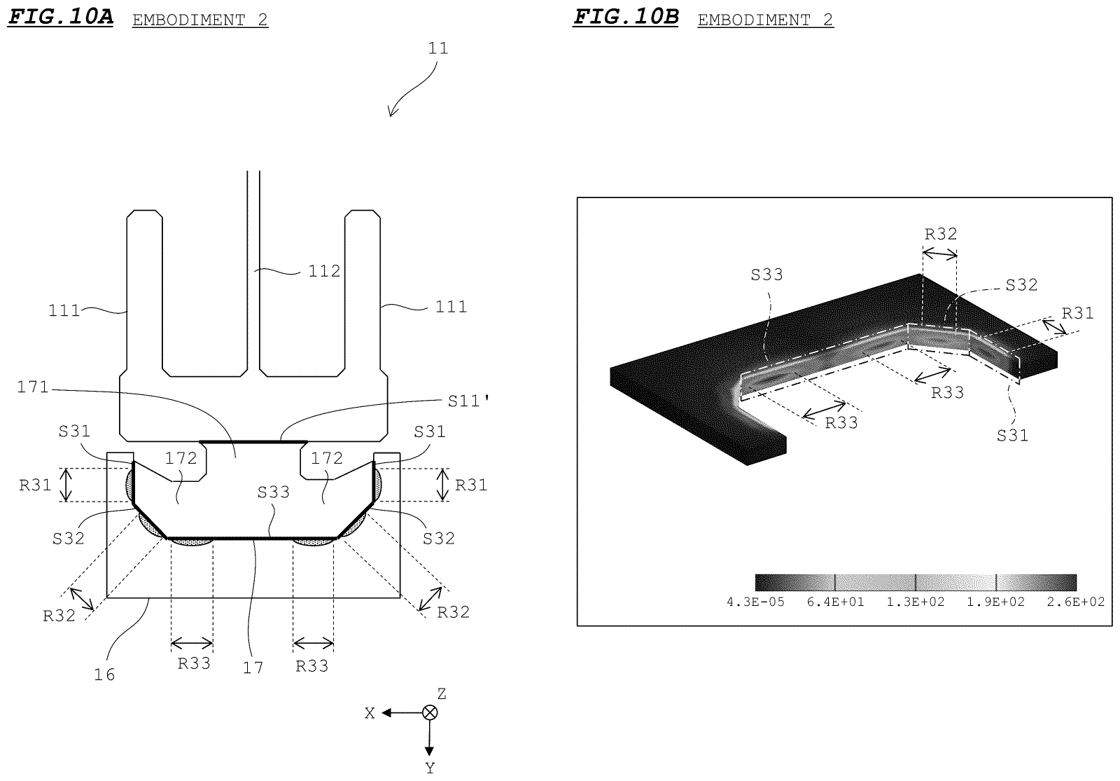

FIG. 10A is a plan view showing ranges R31, R32, and R33 where stress is increased on the joint surfaces S31, S32, and S33 according to Embodiment 2. FIG. 10B is a diagram showing a simulation result of examining stress distribution states on the joint surfaces S31, S32, and S33 according to Embodiment 2. For convenience, in FIG. 10B, a simulation result with a minimum value in blue and a maximum value in red is shown in grayscale.

As in the case of FIG. 6B, FIG. 10B shows a stress distribution when the movable part 30 was rotated at a maximum deflection angle. FIG. 10A and FIG. 10B show the stress distributions on the joint surfaces S31, S32, and S33 of the first drive unit 10 in the configuration of Embodiment 2, but stress distributions on the joint surfaces S41, S42, and S43 of the second drive unit 20 in the configuration of Embodiment 2 are the same as in FIG. 10A and FIG. 10B.

As shown in FIG. 10A and FIG. 10B, in the configuration of Embodiment 2, stress is dispersed to the ranges R31, R32, and R33 on the joint surfaces S31, S32, and S33. In addition, the magnitudes of stress generated on the joint surfaces S31, S32, and S33 are significantly reduced compared to Embodiment 1, as can be seen by comparing the scale of FIG. 6B with the scale of FIG. 10B. From the simulation result, it is confirmed that in the configuration of Embodiment 2, the stress generated on the joint surface between the fixing part 16 and the connection part 17 can be further reduced as compared to the configuration of Embodiment 1.

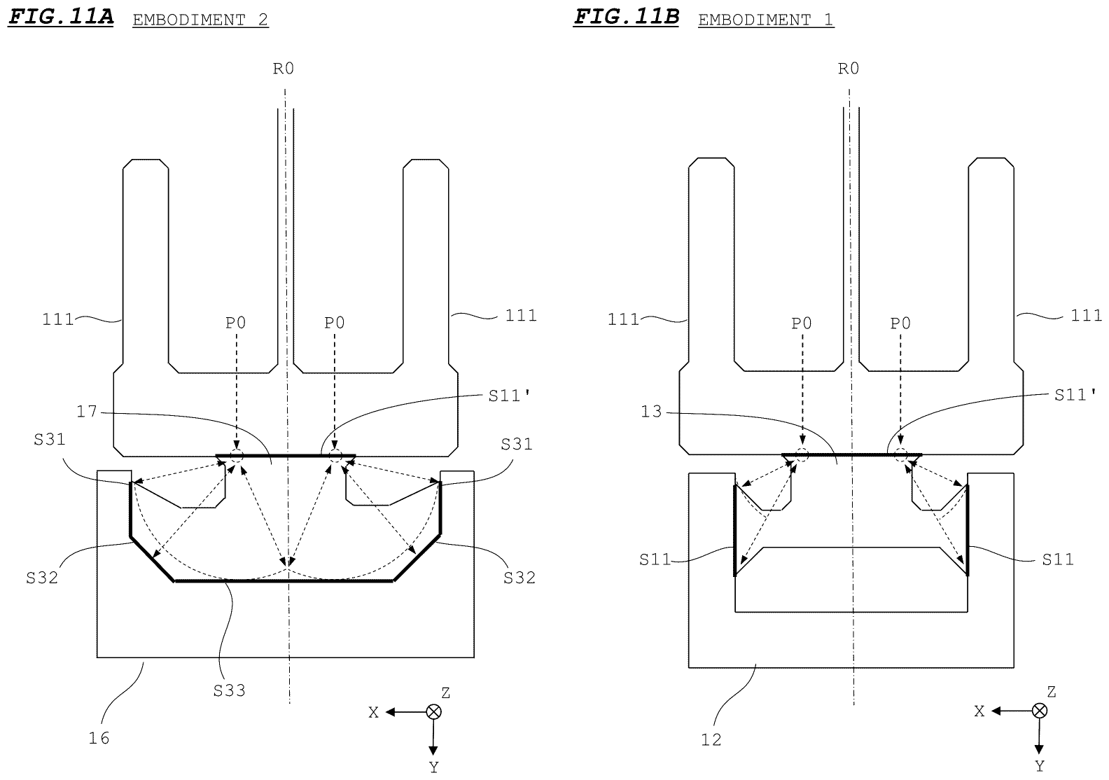

FIG. 11A is a diagram illustrating dispersion of stress according to Embodiment 2, and FIG. 11B is a diagram illustrating dispersion of stress according to Embodiment 1.

As shown in FIG. 11A, in the configuration of Embodiment 2, the total area of the joint surfaces S31 to S33 is larger than the total area of the joint surfaces S11 of Embodiment 1 shown in FIG. 11B. Therefore, in the configuration of Embodiment 2, as compared to the configuration of Embodiment 1, stress is likely to be dispersed more widely to the joint surfaces S31 to S33, and as a result, the stress generated on the joint surfaces S31 to S33 is more likely to be alleviated.

In addition, the stress generated on the joint surfaces between the connection parts 13 and 17 and the fixing parts 12 and 16 is likely to be more evenly dispersed as the distances between the positions P0 at which the stress is localized on the joint surfaces between the connection parts 13 and 17 and the arm portions 111 and the joint surfaces between the connection parts 13 and 17 and the fixing parts 12 and 16 become closer to being constant.

Meanwhile, in the configuration of Embodiment 1, since the joint surfaces S11 extend only in the Y-axis direction, the difference in distance between the end portion in the Y-axis direction of each joint surface S11 and each position P0 tends to be large. On the other hand, in the configuration of Embodiment 2, since the joint surfaces S31, S32, and S33 on one side are placed so as to surround one position P0, and the joint surfaces S31, S32, and S33 on the other side are placed so as to surround the other position P0, the difference in distance from each position P0 to the joint surfaces S31, S32, and S33 is small. Therefore, in the configuration of Embodiment 2, stress is likely to be more evenly dispersed to the joint surfaces S31, S32, and S33 than in the configuration of Embodiment 1.

As described above, in the configuration of Embodiment 2, as compared to the configuration of Embodiment 1, the stress generated on the joint surfaces S31 to S33 is likely to be alleviated, and stress is likely to be more evenly dispersed to the joint surfaces S31, S32, and S33. Accordingly, in the configuration of Embodiment 2, it can be inferred that, as in the above simulation result, the maximum stress on the joint surfaces S31, S32, and S33 is more effectively reduced than in Embodiment 1.

### Effects of Embodiment 2

In the configuration of Embodiment 2, since the two pairs of joint surfaces S31 and S32 which are symmetrical with respect to the rotation axis R0 are not perpendicular to the rotation axis R0, as compared to the case where the joint surface S10 is perpendicular to the rotation axis R0 as in the comparative example shown in FIG. 4, the stress generated on the joint surfaces S31 and S32 generated during rotation of the movable part 30 is likely to be spread and dispersed over the joint surfaces S31 and S32, so that localization of high stress on a part of the joint surfaces S31 and S32 is alleviated. Therefore, as in Embodiment 1 described above, even when the movable part 30 is driven at a high frequency and a high deflection angle, occurrence of breaking of the connection part 13 due to the stress generated during the drive can be suppressed, and deflection of and scanning with light can be performed at a high frequency and a high deflection angle by the reflection surface 40.

As shown in FIG. 9, the joint surface between the connection part 17 and the fixing part 16 includes a first pair of joint surfaces S31 and a second pair of joint surfaces S32 which are positioned farther from the drive part 11 than the first pair of joint surfaces S31 and which have a larger inclination angle relative to the rotation axis R0 than the first pair of joint surfaces S31. Accordingly, as shown in FIG. 11A, the joint surfaces S31 and S32 are placed so as to surround the positions P0 at which high stress is localized on the joint surface S11′, and the distances between the positions P0 and the joint surfaces S31 and S32 are likely to become closer to being constant. Therefore, as described above, stress is likely to be evenly dispersed to the joint surfaces S31 and S32, and the maximum stress generated on the joint surfaces S31 and S32 can be more effectively reduced.

In the configuration of Embodiment 2, the first pair of joint surfaces S31 are parallel to the rotation axis R0, and the second pair of joint surfaces S32 are non-parallel to the rotation axis R0. However, the first pair of joint surfaces S31 may not necessarily be parallel to the rotation axis R0, and may be, for example, inclined relative to the rotation axis R0 at a gentler angle than the second pair of joint surfaces S32.

<Modifications>

The joining mode between the connection part and the fixing part is not limited to the joining modes shown in Embodiments 1 and 2 described above, and various modifications can be made thereto.

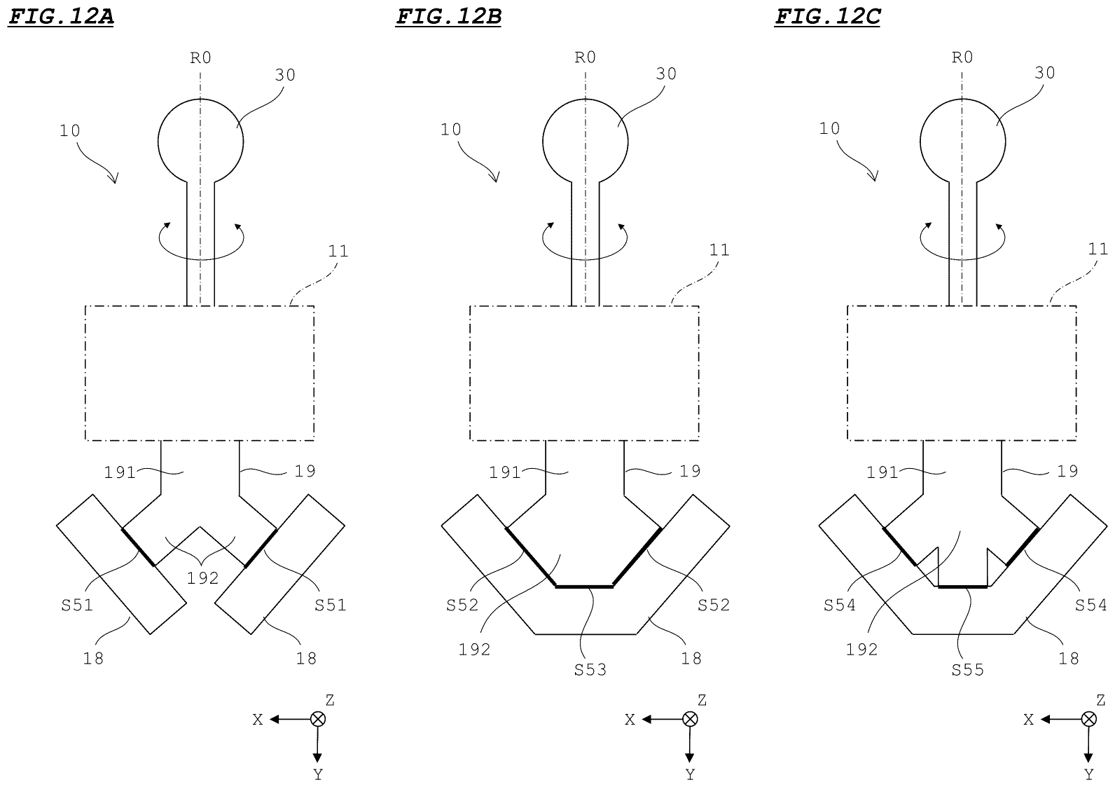

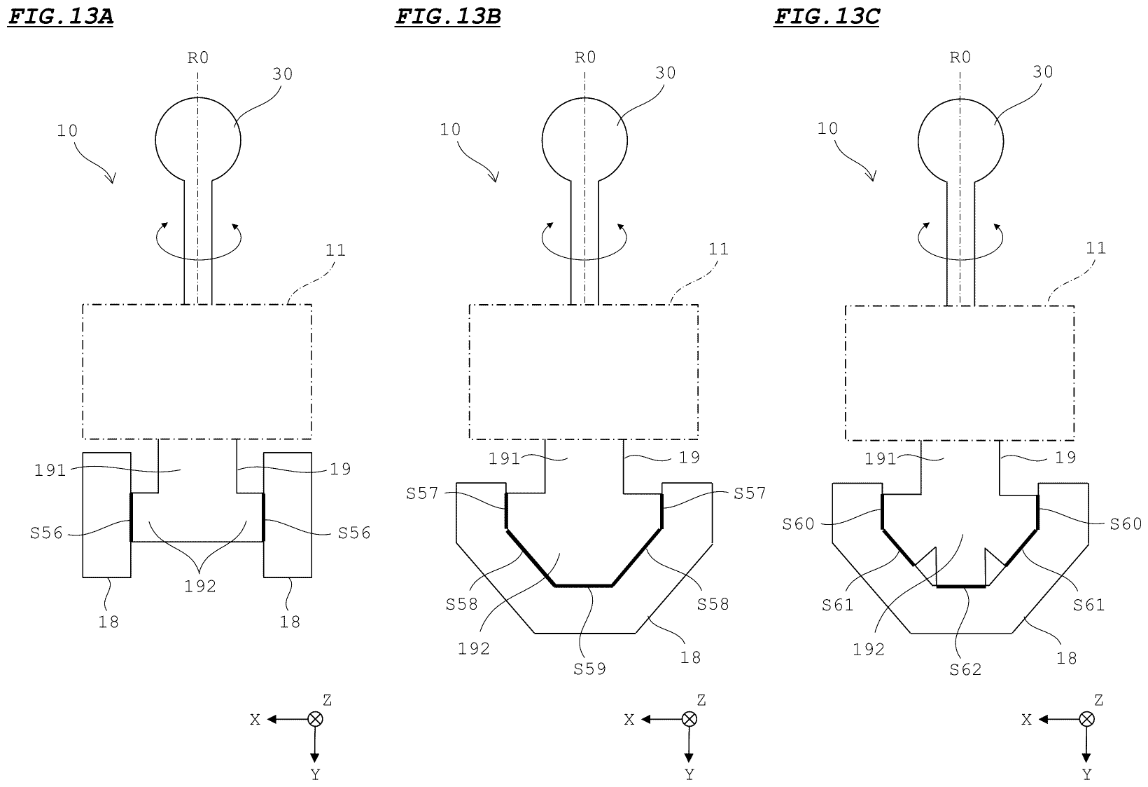

FIG. 12A to FIG. 12C and FIG. 13A to FIG. 13C are each a plan view schematically showing a joining mode between a connection part and a fixing part according to a modification.

In each of the modifications in FIG. 12A to FIG. 12C and FIG. 13A to FIG. 13C, the second drive unit 20 shown in each of Embodiments 1 and 2 described above is omitted, and the first drive unit 10 is placed only on the Y-axis positive side of the movable part 30. In addition, for convenience, in FIG. 12A to FIG. 12C and FIG. 13A to FIG. 13C, the specific configuration of the drive part 11 is not shown.

In the configuration in FIG. 12A, a fixing part 18 is divided into two fixing parts 18, and a connection part 19 is connected to the two fixing parts 18. The connection part 19 includes a support portion 191 extending along the rotation axis R0 from the drive part 11, and a leg portion 192 connected to the support portion 191, and the leg portion 192 is connected to the fixing parts 18 via a pair of joint surfaces S51. The pair of joint surfaces S51 are not orthogonal to the rotation axis R0 and are located so as to be symmetrical with respect to the rotation axis R0. The pair of joint surfaces S51 are non-parallel to the rotation axis R0.

In the configuration in FIG. 12B, a leg portion 192 is connected to one fixing part 18 via a pair of joint surfaces S52 and a joint surface S53. The pair of joint surfaces S52 are not orthogonal to the rotation axis R0 and are located so as to be symmetrical with respect to the rotation axis R0. The pair of joint surfaces S52 are non-parallel to the rotation axis R0. The joint surface S53 is perpendicular to the rotation axis R0. The boundaries of the pair of joint surfaces S52 and the joint surface S53 are contiguous to each other.

In the configuration in FIG. 12C, a leg portion 192 is connected to one fixing part 18 via a pair of joint surfaces S54 and a joint surface S55. The pair of joint surfaces S54 are not orthogonal to the rotation axis R0 and are located so as to be symmetrical with respect to the rotation axis R0. The pair of joint surfaces S54 are non-parallel to the rotation axis R0. The joint surface S55 is perpendicular to the rotation axis R0. The boundaries of the pair of joint surfaces S54 and the joint surface S55 are separated from each other.

In the configuration in FIG. 13A, a fixing part 18 is divided into two fixing parts 18, and a connection part 19 is connected to the two fixing parts 18. The connection part 19 includes a support portion 191 extending along the rotation axis R0 from the drive part 11, and a leg portion 192 connected to the support portion 191, and the leg portion 192 is connected to the fixing parts 18 via a pair of joint surfaces S56. The pair of joint surfaces S56 are not orthogonal to the rotation axis R0 and are located so as to be symmetrical with respect to the rotation axis R0. The pair of joint surfaces S56 are parallel to the rotation axis R0.

In the configuration in FIG. 13B, a leg portion 192 is connected to one fixing part 18 via a pair of joint surfaces S57, a pair of joint surfaces S58, and a joint surface S59. The pair of joint surfaces S57 and the pair of joint surfaces S58 are not orthogonal to the rotation axis R0 and are located so as to be symmetrical with respect to the rotation axis R0. The pair of joint surfaces S57 are parallel to the rotation axis R0, and the pair of joint surfaces S58 are non-parallel to the rotation axis R0. The joint surface S59 is perpendicular to the rotation axis R0. The boundaries of the pair of joint surfaces S57, the pair of joint surfaces S58, and the joint surface S59 are contiguous to each other.

In the configuration in FIG. 13C, a leg portion 192 is connected to one fixing part 18 via a pair of joint surfaces S60, a pair of joint surfaces S61, and a joint surface S62. The pair of joint surfaces S60 and the pair of joint surfaces S61 are not orthogonal to the rotation axis R0 and are located so as to be symmetrical with respect to the rotation axis R0. The pair of joint surfaces S60 are parallel to the rotation axis R0, and the pair of joint surfaces S61 are non-parallel to the rotation axis R0. The joint surface S62 is perpendicular to the rotation axis R0. The boundaries of the pair of joint surfaces S60 and the pair of joint surfaces S61 are separated from the boundary of the joint surface S62.

With any of the configurations in FIG. 12A to FIG. 12C and FIG. 13A to FIG. 13C, the maximum stress generated on the joint surfaces can be reduced as compared to the case of having only joint surfaces perpendicular to the rotation axis R0 as in the above comparative example. In addition, in the configurations in FIG. 12B and FIG. 12C, as compared to the configuration in FIG. 12A, the total area of the joint surfaces is large, and thus the stress generated on the joint surfaces can be further reduced. In the configurations in FIG. 13B and FIG. 13C, as compared to the configuration in FIG. 13A, the total area of the joint surfaces is large, and thus the stress generated on the joint surfaces can be further reduced. Moreover, in the configurations in FIG. 13B and FIG. 13C, as compared to the configurations in FIG. 12B and FIG. 12C, the number of pairs of joint surfaces is large, the total area of the joint surfaces is large, and thus the stress generated on the joint surfaces can be even further reduced.

In FIG. 12A to FIG. 12C and FIG. 13A to FIG. 13C, the configuration examples of the case where only the first drive unit 10 is placed are shown, but a second drive unit 20 having the same configuration as each of these first drive units 10 may be further placed on the Y-axis negative side of the movable part 30 in an orientation opposite to that of the first drive unit 10 and be connected to the movable part 30.

<Other Modifications>

In Embodiments 1 and 2 and the modifications described above, the drive parts 11 and 21 are tuning fork-type vibrators. However, the drive parts 11 and 21 are not limited thereto. For example, the drive parts 11 and 21 may be meander-type vibrators.

In Embodiments 1 and 2 and the modifications described above, the shape of the movable part 30 is a circular shape, but may be another shape such as a square shape. The shape of the drive element 1 in a plan view and the dimensions of each part of the drive element 1 can also be changed as appropriate.

The drive element 1 may also be used as an element other than the light deflection element 2. In the case where the drive element 1 is used as an element other than the light deflection element, the reflection surface 40 may not necessarily be located on the movable part 30, and another member other than the reflection surface 40 may be placed thereon.

In addition to the above, various modifications can be made as appropriate to the embodiments of the present invention, without departing from the scope of the technological idea defined by the claims.

What is claimed is:

1. A drive element comprising:
a movable part;
a drive part configured to rotate the movable part about a rotation axis; and
a connection part connecting the drive part to a fixing part, wherein
the movable part, the drive part, and the fixing part are aligned along the rotation axis,
the connection part is connected to the fixing part via at least one pair of joint surfaces, and
the pair of joint surfaces are not orthogonal to the rotation axis and are symmetrical with respect to the rotation axis.

2. The drive element according to claim 1, wherein
the connection part includes a support portion extending along the rotation axis from the drive part, and
a total area of the joint surfaces is larger than a cross-sectional area, perpendicular to the rotation axis, of the support portion.

3. The drive element according to claim 1, wherein the pair of joint surfaces are parallel to the rotation axis.

4. The drive element according to claim 1, wherein the pair of joint surfaces are non-parallel to the rotation axis.

5. The drive element according to claim 1, wherein said at least one pair of joint surfaces include
a first pair of joint surfaces, and
a second pair of joint surfaces positioned farther from the drive part than the first pair of joint surfaces and having a larger inclination angle relative to the rotation axis than the first pair of joint surfaces.

6. The drive element according to claim 5, wherein the first pair of joint surfaces are parallel to the rotation axis.

7. The drive element according to claim 1, wherein
two drive units each including the drive part, the connection part, and the fixing part are placed in orientations opposite to each other with the movable part located therebetween, and
the drive part of each drive unit is connected to the movable part.

8. The drive element according to claim 1, wherein the drive part is a tuning fork-type vibrator.

9. The drive element according to claim 1, wherein the drive part has a piezoelectric thin film as a drive source.

10. A light deflection element comprising:
a drive element; and
a reflection surface, wherein
the drive element includes
a movable part,
a drive part configured to rotate the movable part about a rotation axis, and
a connection part connecting the drive part to a fixing part,
the movable part, the drive part, and the fixing part are aligned along the rotation axis,
the connection part is connected to the fixing part via at least one pair of joint surfaces,
the pair of joint surfaces are not orthogonal to the rotation axis and are symmetrical with respect to the rotation axis, and
the reflection surface is located on the movable part.

11. The light deflection element according to claim 10, wherein
the connection part includes a support portion extending along the rotation axis from the drive part, and
a total area of the joint surfaces is larger than a cross-sectional area, perpendicular to the rotation axis, of the support portion.

12. The light deflection element according to claim 10, wherein the pair of joint surfaces are parallel to the rotation axis.

13. The light deflection element according to claim 10, wherein the pair of joint surfaces are non-parallel to the rotation axis.

14. The light deflection element according to claim 10, wherein said at least one pair of joint surfaces include
a first pair of joint surfaces, and
a second pair of joint surfaces positioned farther from the drive part than the first pair of joint surfaces and having a larger inclination angle relative to the rotation axis than the first pair of joint surfaces.

15. The light deflection element according to claim 14, wherein the first pair of joint surfaces are parallel to the rotation axis.

16. The light deflection element according to claim 10, wherein
two drive units each including the drive part, the connection part, and the fixing part are placed in orientations opposite to each other with the movable part located therebetween, and
the drive part of each drive unit is connected to the movable part.

17. The light deflection element according to claim 10, wherein the drive part is a tuning fork-type vibrator.

18. The light deflection element according to claim 10, wherein the drive part has a piezoelectric thin film as a drive source.
